(19) United States
(12) Patent Application Publication
(10) Pub. No.: US 2026/0087359 A1
(43) Pub. Date: Mar. 26, 2026

(54) INFORMATION PROCESSING APPARATUS, UPDATE METHOD, AND NON-TRANSITORY COMPUTER READABLE MEDIUM

(71) Applicant: NEC Corporation, Tokyo (JP)

(72) Inventor: Jun YOSHIDA, Tokyo (JP)

(73) Assignee: NEC Corporation, Tokyo (JP)

(21) Appl. No.: 19/326,051

(22) Filed: Sep. 11, 2025

(30) Foreign Application Priority Data
Sep. 26, 2024 (JP) 2024-167534

(51) Int. Cl. G06N 3/092; G06N 3/0475

(52) U.S. Cl. CPC G06N 3/092; G06N 3/0475

(57) ABSTRACT

A transformation model that transforms an input query into a feature vector can be updated based on any evaluation criterion. An information processing apparatus includes an evaluation unit that evaluates related information detected by search using a feature vector obtained by transforming an input query with a transformation model, by using an evaluation model that receives data to be evaluated and an evaluation criterion to output an evaluation result, and a training unit that updates the transformation model based on the evaluation result of the evaluation unit. The information processing apparatus makes it possible to optimize the transformation model according to a task or a user and to support decision-making.

### INCORPORATION BY REFERENCE

This application is based upon and claims the benefit of priority from Japanese patent application No. 2024-167534, filed on Sep. 26, 2024, the disclosure of which is incorporated herein in its entirety by reference.

### TECHNICAL FIELD

The present disclosure relates to an information processing apparatus, an update method, and an update program.

### BACKGROUND ART

There is known a technique for generating an answer based on related information by inputting, in addition to a query, related information of the query detected by search to a large-scale language model in a case of generating an answer to the input query in the large-scale language model. Such a technique is called retrieval-augmented generation (RAG). As a related art document disclosed for retrieval-augmented generation, for example, Japanese Patent No. 7325152 below can be cited.

In the language model system disclosed in Japanese Patent No. 7325152, a text DB is searched using a feature vector calculated using an embedding model from a query sentence input by a user terminal, and a text having a feature vector similar to the calculated feature vector is acquired. Then, in the language model system, a prompt in which the text acquired as described above is added to the input query sentence is input to a large language model (LLM), and an answer to the query sentence is generated.

### SUMMARY

In the language model system disclosed in Japanese Patent No. 7325152, the accuracy of the feature vector generated from the query sentence greatly affects the accuracy of the generated answer. That is, in a case where an appropriate feature vector according to the intention of the user's query is generated, a text according to the intention is detected from the text DB, and an appropriate answer based on the text is generated. On the other hand, in a case where a feature vector not conforming to the intention of the user's query is generated, a text irrelevant to the user's intention may be detected from the text DB, and an incorrect answer may be generated.

For this reason, it is important to appropriately train the embedding model in such a way that a highly accurate feature vector is generated. However, a determination criterion of the quality of the text detected by the search may be different depending on a task to be executed by the language model or a user. For example, for a user who prefers a factual answer, a highly factual text is “appropriate” related information, whereas for a user who prefers a creative answer, a text including a creative content is “appropriate” related information.

Therefore, in the retrieval-augmented generation, it is desirable to update the Embedding model, that is, a transformation model that transforms the input query into the feature vector, based on any evaluation criterion. However, the language model system disclosed in Japanese Patent No. 7325152 cannot perform such an update. An example object of the present disclosure is to provide a technology that enables a transformation model that transforms an input query into a feature vector to be updated based on any evaluation criterion.

An information processing apparatus according to an example aspect of the present disclosure includes an evaluation unit that evaluates related information on an input query detected by search using a feature vector obtained by transforming the query with a transformation model, by using an evaluation model that receives data to be evaluated and an evaluation criterion to output an evaluation result obtained by evaluating the data with the evaluation criterion, and a training unit that updates the transformation model based on the evaluation result of the evaluation unit.

An update method according to an example aspect of the present disclosure causes at least one processor to execute evaluation processing of evaluating related information on an input query detected by search using a feature vector obtained by transforming the query with a transformation model, by using an evaluation model that receives data to be evaluated and an evaluation criterion to output an evaluation result obtained by evaluating the data with the evaluation criterion, and update processing of updating the transformation model based on the evaluation result of the evaluation processing.

An update program according to an example aspect of the present disclosure causes a computer to function as an evaluation unit that evaluates related information on an input query detected by search using a feature vector obtained by transforming the query with a transformation model, by using an evaluation model that receives data to be evaluated and an evaluation criterion to output an evaluation result obtained by evaluating the data with the evaluation criterion, and a training unit that updates the transformation model based on the evaluation result of the evaluation unit.

According to an example aspect of the present disclosure, there is an example effect that a transformation model that transforms an input query into a feature vector can be updated based on any evaluation criterion.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of an update method according to the present disclosure;

FIG. 3 is a block diagram illustrating a configuration of another information processing apparatus according to the present disclosure;

FIG. 4 is a diagram illustrating an example of generation of an answer to a query and update of a transformation model by the information processing apparatus illustrated in FIG. 3;

FIG. 5 is a flowchart illustrating a flow of processing executed by the information processing apparatus illustrated in FIG. 3; and

FIG. 6 is a block diagram illustrating a configuration of a computer that functions as the information processing apparatus according to the present disclosure.

### EXAMPLE EMBODIMENT

Hereinafter, example embodiments of the present disclosure will be described. However, the present disclosure is not limited to the example embodiments to be described below, and various modifications can be made within the scope described in the claims. For example, example embodiments obtained by appropriately combining techniques (some or all of things or methods) adopted in the following example embodiments can also be included in the scope of the present disclosure. Example embodiments obtained by appropriately omitting some of the techniques adopted in the following example embodiments can also be included in the scope of the present disclosure. Advantages mentioned in the following example embodiments are examples of advantages expected in the example embodiments, and do not define extensions of the present disclosure. That is, example embodiments that do not achieve the effects mentioned in the following example embodiments can also be included in the scope of the present disclosure.

### First Example Embodiment

A first example embodiment that is an example of an example embodiment of the present disclosure will be described in detail with reference to the drawings. The present example embodiment is a basic form of each example embodiment to be described below. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in the drawings referred to for describing the present example embodiment can also be adopted in the other example embodiments included in the present disclosure within a range in which no particular technical problem occurs.

### (Configuration of Information Processing Apparatus 1)

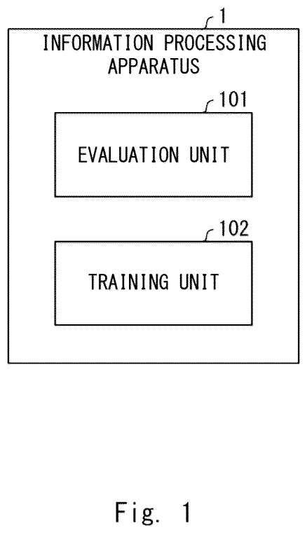

A configuration of an information processing apparatus 1 according to the present example embodiment will be described with reference to FIG. 1. FIG. 1 is a block diagram illustrating a configuration of the information processing apparatus 1. As illustrated in FIG. 1, the information processing apparatus 1 includes an evaluation unit 101 and a training unit 102.

The evaluation unit 101 evaluates the related information of the query. Here, the “query” means an inquiry or a request. This query may be input by a person (for example, the user of the information processing apparatus 1) or may be generated by the information processing apparatus 1 or another apparatus. Typically, the query is text data representing the contents of the query or request in a natural language. However, any data format of the query is applied. For example, a query in which a plurality of data formats such as a combination of image data (may be moving image data or still image data) and text data are mixed may be applied.

The “related information” is information related to the query. More specifically, the related information is information detected by search using a feature vector obtained by transforming the query by a transformation model. Therefore, it can be said that the query and the related information are related in that feature vectors indicating the features thereof are similar. Any data format of the related information is also applied.

The “transformation model” is a model that transforms input data into a feature vector representing a feature of the data. For example, the embedding model described in the background art can also be used as the transformation model. The transformation model can be generated by machine learning a relationship between input data and a feature vector representing a feature of the data. As the transformation model, one associated with the data format of the query to be transformed may be used. For example, if the query is text data described in a natural language, a transformation model capable of transforming the text data described in the natural language into a feature vector may be used. In a case where the query includes text data and image data, a transformation model capable of transforming both the text data and the image data into feature vectors may be used. A transformation model capable of transforming text data into a feature vector and a transformation model capable of transforming image data into a feature vector may be used in combination.

The transformation model may be incorporated in a generation model that generates an answer to the query. This generation model is a model that generates an answer to the query using the feature vector generated by the transformation model. As such a generation model, for example, a language model obtained by machine learning an arrangement of components (words and the like) in a sentence in a natural language or an arrangement of a sentence and a sentence in a text can be applied. Examples of such a language model include bidirectional encoder representations from transformers (BERT), robustly optimized BERT approach (ROBERTa), efficiently learning an encoder that classifies token replacements accurately (ELECTRA), and the like.

The evaluation unit 101 evaluates the above-described related information using a predetermined evaluation model. The “evaluation model” is a model that receives data to be evaluated and an evaluation criterion to output an evaluation result obtained by evaluating the data based on the evaluation criterion. Therefore, the evaluation unit 101 inputs the related information and the evaluation criteria to be applied to the evaluation of the related information to the evaluation model, thereby being capable of outputting the evaluation result obtained by evaluating the related information by the evaluation criteria. The evaluation unit 101 may directly use the output of the evaluation model as the evaluation result, or may generate the evaluation result using the output of the evaluation model. The evaluation result may be an index indicating the quality or validity of the related information. The evaluation model will be described in more detail in a second example embodiment.

The training unit 102 updates the transformation model based on the evaluation result of the evaluation unit 101. Here, updating the transformation model based on the evaluation result means updating the parameters (parameters to be updated by training) of the transformation model in such a way as to generate a feature vector in which the related information having good evaluation result evaluated according to the evaluation criteria is likely to be detected. The feature vector in which the related information having a good evaluation result evaluated according to the evaluation criteria is likely to be detected is a feature vector having a high degree of similarity to a feature vector of related information having a good evaluation result evaluated according to the evaluation criteria. Therefore, it can also be said that the training unit 102 updates the parameters of the transformation model in such a way as to generate a feature vector having a high degree of similarity to a feature vector of related information having a good evaluation result evaluated according to the evaluation criteria. The update of the transformation model will be described in more detail in a second example embodiment.

As described above, the information processing apparatus 1 according to the present example embodiment includes an evaluation unit 101 that evaluates related information on an input query detected by search using a feature vector obtained by transforming the query with a transformation model, by using an evaluation model that receives data to be evaluated and an evaluation criterion to output an evaluation result obtained by evaluating the data with the evaluation criterion, and a training unit 102 that updates the transformation model based on the evaluation result of the evaluation unit 101.

According to the above configuration, the related information of the query is evaluated using the evaluation model that receives the data to be evaluated and the evaluation criteria to output the evaluation result obtained by evaluating the data with the evaluation criteria. Since this evaluation model outputs the evaluation result evaluated by the evaluation criteria by inputting the evaluation criteria, it is possible to evaluate the related information by any evaluation criteria by using this evaluation model. Then, according to the above configuration, the transformation model is updated based on the evaluation result of the evaluation unit 101.

Therefore, according to the above configuration, it is possible to obtain an effect that the transformation model that transforms the input query into the feature vector can be updated based on any evaluation criterion. Therefore, according to the information processing apparatus 1, the transformation model can be optimized according to a task or the user. In this update, it is not necessary for the user to prepare training data (input data of the model is labeled with ground truth data) generally required in a case of updating the trained model. Therefore, the above configuration also has an advantage that the transformation model can be updated while human cost is suppressed.

### (Update Program)

The functions of the information processing apparatus 1 described above can also be achieved by a program. An update program according to the present example embodiment, which is a transformation model update program for causing a computer to function as an evaluation unit that evaluates related information on an input query detected by search using a feature vector obtained by transforming the query with a transformation model, by using an evaluation model that receives data to be evaluated and an evaluation criterion to output an evaluation result obtained by evaluating the data with the evaluation criterion, and a training unit that updates the transformation model based on the evaluation result of the evaluation unit. According to this update program, the transformation model that transforms the input query into the feature vector can be updated based on any evaluation criterion.

### (Flow of Update Method)

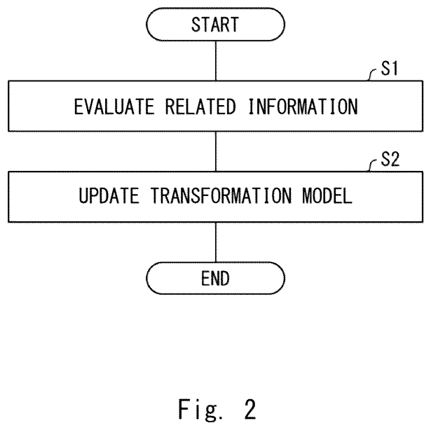

A flow of an update method according to the present example embodiment will be described with reference to FIG. 2. FIG. 2 is a flowchart illustrating a flow of an update method. The execution subject of each step in this update method may be a processor included in the information processing apparatus 1, may be a processor included in another apparatus, or may be a processor in which the execution subject of each step is provided in a different apparatus.

In S1 (evaluation processing), at least one processor evaluates the related information on the query detected by the search using the feature vector obtained by transforming the input query by the transformation model by using an evaluation model that receives data to be evaluated and an evaluation criterion to output an evaluation result obtained by evaluating the data with the evaluation criterion.

In S2 (update processing), at least one processor updates the transformation model based on the evaluation result of S1.

As described above, the update method according to the present example embodiment is a method of updating a transformation model for causing at least one processor to execute evaluation processing of evaluating related information on an input query detected by search using a feature vector obtained by transforming the query with a transformation model, by using an evaluation model that receives data to be evaluated and an evaluation criterion to output an evaluation result obtained by evaluating the data with the evaluation criterion, and update processing of updating the transformation model based on the evaluation result of the evaluation processing. Therefore, according to the update method according to the present example embodiment, the transformation model that transforms the input query into the feature vector can be updated based on any evaluation criterion.

### Second Example Embodiment

A second example embodiment that is an example of an example embodiment of the present disclosure will be described in detail with reference to the drawings. Components having the same functions as the components described in the above-described example embodiment will be denoted by the same reference numerals, and the description thereof will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in each of the drawings referred to for describing the present example embodiment can be employed in the other example embodiments included in the present disclosure within the scope in which no particular technical problem occurs.

### (Configuration of Information Processing Apparatus 1A)

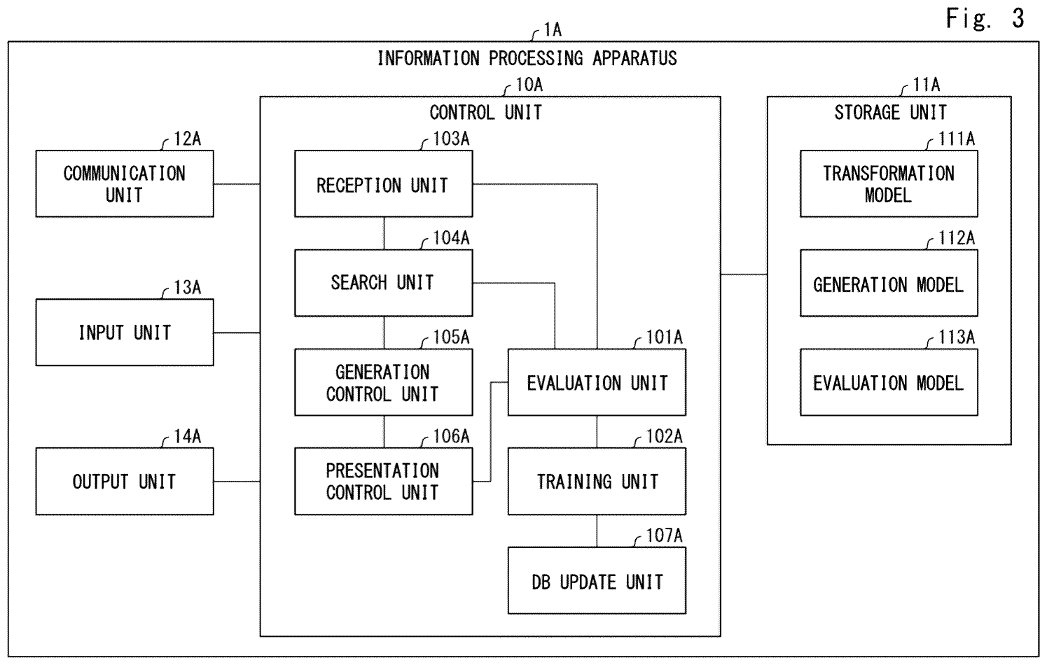

A configuration of an information processing apparatus 1A according to the present example embodiment will be described with reference to FIG. 3. FIG. 3 is a block diagram illustrating the configuration of the information processing apparatus 1A. The information processing apparatus 1A is an apparatus having a function of receiving an input of a query and outputting an answer to the query. The information processing apparatus 1A may be a local apparatus used by individual users, or may be a server that provides a service for generating answers to queries for a plurality of users.

As illustrated, the information processing apparatus 1A includes a control unit 10A that integrally controls units of the information processing apparatus 1A, and a storage unit 11A that stores various types of data to be used by the information processing apparatus 1A. The information processing apparatus 1A includes a communication unit 12A for the information processing apparatus 1A to communicate with another apparatus, an input unit 13A that receives an input to the information processing apparatus 1A, and an output unit 14A for the information processing apparatus 1A to output data. Then, the control unit 10A includes an evaluation unit 101A, a training unit 102A, a reception unit 103A, a search unit 104A, a generation control unit 105A, a presentation control unit 106A, and a database (DB) update unit 107A. The storage unit 11A stores a transformation model 111A, a generation model 112A, and an evaluation model 113A. The DB update unit 107A will be described later in the section of “Database update method”.

Similarly to the evaluation unit 101 of the first example embodiment, the evaluation unit 101A evaluates, using the evaluation model 113A, the related information on the query detected by the search using the feature vector obtained by transforming the input query by the transformation model 111A.

Similarly to the model having the same name described in the first example embodiment, the transformation model 111A is a model that transforms input data into a feature vector representing a feature of the data.

Similarly to the model having the same name described in the first example embodiment, the evaluation model 113A is a model that receives data to be evaluated and an evaluation criterion to output an evaluation result obtained by evaluating the data based on the evaluation criterion. The evaluation model 113A can be generated by machine learning.

For example, the evaluation model 113A may be a language model that has been trained on a natural language. As a result, in addition to the effect obtained by the information processing apparatus 1, it is possible to obtain an effect that the evaluation result can be output by directly inputting the evaluation criteria described in the natural language to the evaluation model 113A. Here, training a natural language more specifically means training an arrangement of components (words and the like) in a sentence in a natural language or an arrangement of a sentence and a sentence in a text.

A model such as a vision and language model (VLM), which is a type of the language model and receives input of image data and text data, may be used as the evaluation model 113A. As a result, it is possible to input the related information, which is the image data, to the evaluation model 113A as it is and to perform evaluation.

The training unit 102A updates the transformation model 111A based on the evaluation result of the evaluation unit 101A, similarly to the training unit 102 of the first example embodiment. Details of the update method will be described later in the item of “Update method of transformation model”.

The reception unit 103A receives various inputs by the user of the information processing apparatus 1A. For example, the reception unit 103A receives an input of the above-described query. For example, the reception unit 103A receives designation of an evaluation criterion for evaluating the related information of the query. Such input and designation may be performed via the input unit 13A or via the communication unit 12A. In the latter case, the user designates the input of the query and the evaluation criteria by the terminal device used by the user.

The search unit 104A retrieves related information related to the input query. More specifically, the search unit 104A inputs the query input by the reception unit 103A to the transformation model 111A to transform the query into the feature vector. Then, the search unit 104A performs vector search using the feature vector obtained by the transformation, and detects related information related to the query.

The generation control unit 105A inputs the query input by the reception unit 103A and the related information detected by the search unit 104A to the generation model 112A, and generates an answer to the query. Any data format of the answer is applied. For example, the answer may be text data, image data (still image data or moving image data), or a combination thereof. The generation control unit 105A may input the feature vector generated by the search unit 104A inputting the query to the transformation model 111A to the generation model 112A instead of the query input by the reception unit 103A.

The generation model 112A is a model that generates an answer to the query. Various models associated with the answer desired to be generated can be applied as the generation model 112A. For example, a language model such as BERT that has been trained on natural language can be applied as the generation model 112A, or a model that generates an image according to an input query can be applied as the generation model 112A.

The transformation model 111A and the generation model 112A may be integrally configured as one model. In this case, the feature vector of the query generated by the transformation model 111A is used for vector search by the search unit 104A, and is used for generating an answer to the query together with the related information detected by the search.

The presentation control unit 106A performs control to present various types of information to the user. For example, the presentation control unit 106A presents an answer to the query to the user. For example, the presentation control unit 106A may present the evaluation result by the evaluation unit 101A to the user. The presentation mode may be any mode as long as the presented content can be recognized by the subject. For example, the presentation control unit 106A may transmit information to be presented to a terminal device of the user via the communication unit 12A, and may present the information by causing the terminal device to perform display output or voice output. For example, the presentation control unit 106A may present information to be presented by causing the output unit 14A to output the information.

### (Example of Processing)

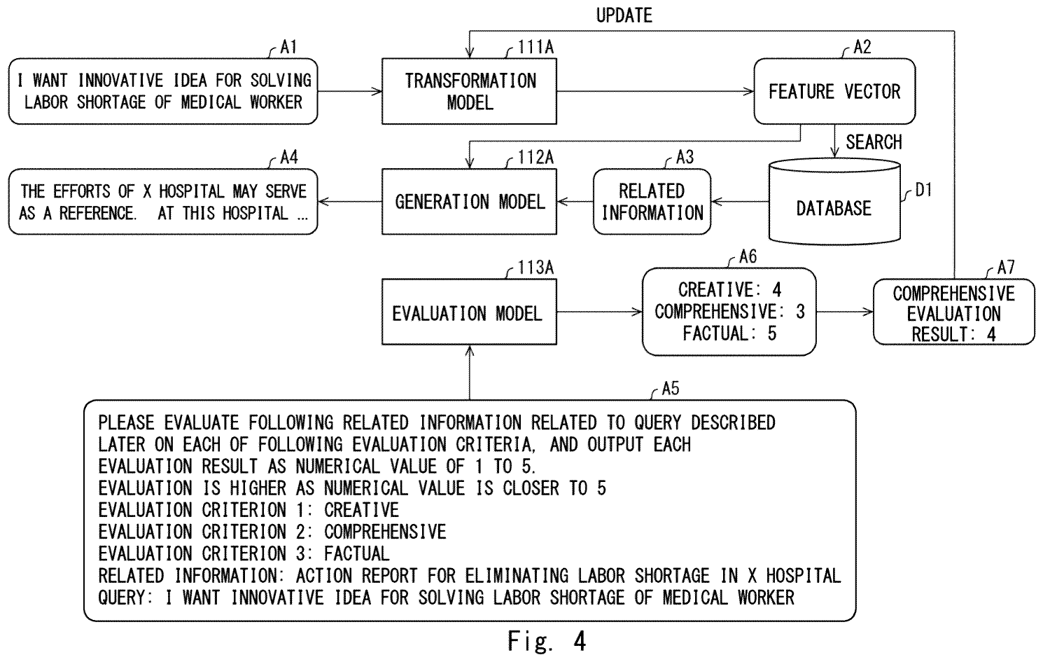

An example of processing executed by the information processing apparatus 1A will be described with reference to FIG. 4. FIG. 4 is a diagram illustrating an example of generation of an answer to a query and update of the transformation model 111A by the information processing apparatus 1A. The query input in the example of FIG. 4 is a query A1 illustrated in FIG. 4. Specifically, the query A1 is text data in a natural language of “I want an innovative idea for solving the labor shortage of medical workers”.

Upon receiving the input of the query A1, the reception unit 103A outputs the received query A1 to the search unit 104A. The reception unit 103A may receive input of text data of the query A1 or may receive input of voice data of the query A1. In the latter case, the reception unit 103A may acquire text data obtained by performing voice recognition on the input voice data. The voice recognition may be performed by the information processing apparatus 1A or may be performed by another apparatus.

Next, the search unit 104A inputs the query A1 to the transformation model 111A and transforms the query A1 into a feature vector A2. Then, the search unit 104A performs vector search for the database D1 using the feature vector A2, and detects related information A3. In this manner, the search target may be limited to a predetermined database. As a result, it is possible to generate an answer based on the information recorded in the predetermined database.

In the database D1, each piece of information as a candidate for the related information and a feature vector of each piece of information are recorded in association with each other. As a result, the search unit 104A can detect information associated with a feature vector having a high similarity with the feature vector A2 of the query A1 among the information recorded in the database D1, and acquire the information as related information. The search unit 104A can acquire, as the related information A3, a document having contents related to the query A1, for example, “Action Report for Eliminating Labor shortage in X Hospital” among the information recorded in the database D1.

Any similarity calculation method is applied. For example, the search unit 104A may calculate cosine similarity between each feature vector recorded in the database D1 and the feature vector A2. Then, the search unit 104A is only required to acquire, as the related information A3, information associated with a feature vector having a cosine similarity of the feature vector recorded in the database D1 to the feature vector A2 equal to or higher than a predetermined threshold, or each piece of information associated with a predetermined number of feature vectors having a similarity of the feature vector recorded in the database D1 to the feature vector A2 higher.

Next, the generation control unit 105A inputs the acquired related information A3 and feature vector A2 to the generation model 112A. As a result, an answer A4 is output from the generation model 112A. The generated answer A4 is presented to the user by the presentation control unit 106A. The answer A4 is an answer to the query A1, and has contents in consideration of the contents of the related information A3.

The evaluation unit 101A evaluates the related information A3 using the evaluation model 113A. In the example of FIG. 4, the evaluation unit 101A generates a prompt A5 by using the evaluation criteria to be applied to the evaluation of the related information A3, the related information A3 to be evaluated, and the query A1, and inputs the generated prompt A5 to the evaluation model 113A. In this prompt A5, three evaluation criteria 1 to 3 are shown. The prompt A5 is content instructing to output the evaluation result in each of these evaluation criteria as a numerical value of 1 to 5. As a result, the evaluation model 113A outputs an evaluation result A6 in which the evaluation result by each of the three evaluation criteria is indicated by a numerical value in a range of 1 to 5. The prompt A5 can be generated, for example, by inputting the evaluation criteria to be applied, the related information A3 to be evaluated, and the query A1 to a template prepared in advance.

Here, in a case of causing the evaluation model 113A to output the evaluation results for each of the plurality of evaluation criteria, the evaluation unit 101A may combine the evaluation results to generate an overall evaluation result. For example, in the example of FIG. 4, the average value of the evaluation results in each evaluation criterion is calculated as a comprehensive evaluation result A7. The comprehensive evaluation result only needs to be generated based on each evaluation result, and any generation method is applied. For example, in a case where each evaluation result is represented by a numerical value, a statistical value such as a median, a mode, a maximum value, or a minimum value of the numerical values may be used as the comprehensive evaluation result, or a total value of the evaluation results may be used as the comprehensive evaluation result. For example, a weight for each evaluation criterion may be designated by the user, and a weighted average value calculated using the designated weight may be used as the comprehensive evaluation result. As a result, the evaluation result of the evaluation criterion that the user wants to emphasize can be strongly reflected in the update of the transformation model 111A.

Here, the presentation control unit 106A may present the evaluation result of the evaluation unit 101 to the user. As a result, in addition to the effect obtained by the information processing apparatus 1, it is possible to provide the user with information serving as a material for determining the validity of the answer to the query of the evaluation result of the related information. The presentation control unit 106A may present both the evaluation result A6 and the comprehensive evaluation result A7, or may present either one of them.

Next, the training unit 102A updates the transformation model 111A based on the comprehensive evaluation result A7. The evaluation of the related information and the update of the transformation model 111A may be performed every time a query is input, or may be performed every time a predetermined number of query inputs are received, or may be performed every predetermined period.

### (Method of Updating Transformation Model)

The training unit 102A may update the transformation model 111A such that the degree of similarity between the feature vector of the related information and the feature vector of the query becomes higher as the evaluation result by the evaluation unit 101A becomes better. As a result, in the generation of the answer to the next or subsequent query, it is possible to generate the feature vector in which the related information having good evaluation result by the evaluation criterion applied by the evaluation unit 101A is likely to be detected.

For example, the training unit 102A may update the transformation model 111A using a loss function indicating a difference between a probability distribution of similarity between the feature vector of the query and the feature vector of the related information and a probability distribution of a numerical value indicating an evaluation result of the related information. As a result, in the generation of the answer to the next or subsequent query, it is possible to generate the feature vector in which the related information having good evaluation result by the evaluation criterion applied by the evaluation unit 101A is likely to be detected.

Specifically, the training unit 102A first transforms the similarity between the feature vector of the query and the feature vector of the related information into a probability value. This processing is performed for each piece of related information for which the similarity is calculated. As a result, a probability distribution of the similarity is obtained. The training unit 102A similarly obtains a probability distribution of a numerical value indicating an evaluation result of the related information.

In a case where the similarity is transformed into a probability value, a high probability is assigned to a high similarity, and in a case where the evaluation result is transformed into a probability value, a high probability is assigned to a high evaluation result. For example, the training unit 102A may transform each of numerical values indicating the similarity and the evaluation result into a probability value using a softmax function that transforms an input value into a probability value.

The training unit 102A updates the parameters of the transformation model 111A in such a way that the two probability distributions generated as described above are close to each other. Specifically, the training unit 102A generates a loss function indicating a difference between the generated probability distributions. Then, the training unit 102A updates the parameters of the transformation model 111A using the generated loss function. For example, the training unit 102A may generate Kullback-Leibler Divergence indicating a difference between the obtained probability distributions as a loss function. A known method can be applied as a specific method of updating using the Kullback-Leibler Divergence as a loss function.

The training unit 102A may update the transformation model 111A based on the optimal transport theory instead of using the Kullback-Leibler Divergence. In this case, the training unit 102A may use a loss function representing a difference between the probability distribution of the similarity between the feature vector of the query and the feature vector of the related information and the probability distribution of the numerical value indicating the evaluation result of the related information based on the optimal transport theory. This makes it possible to appropriately update the transformation model 111A in consideration of a geometric structure of each probability distribution.

The training unit 102A may update the transformation model 111A by reinforcement training using an evaluation result by the evaluation unit 101A as a reward. In this case, the transformation model 111A is updated in such a way that the evaluation result by the evaluation unit 101A is improved. Even in a case where the update by the reinforcement training is applied, in the generation of the answer to the next or subsequent query, it is possible to generate the feature vector in which the related information having good evaluation result by the evaluation criterion applied by the evaluation unit 101A is likely to be detected.

### (Method of Updating Database)

As described above, the search by the search unit 104A may be performed for a database (for example, the database D1 illustrated in FIG. 4) in which each piece of information that is a candidate for related information and a feature vector of each piece of information are recorded in association with each other. In this case, the DB update unit 107A updates each feature vector recorded in the database with a feature vector obtained by transforming each piece of information recorded in the database by the transformation model 111A updated by the training unit 102A.

According to the information processing apparatus 1A including the DB update unit 107A, in addition to the effect obtained by the information processing apparatus 1, it is possible to obtain an effect that related information having good evaluation result based on the evaluation criteria applied by the evaluation unit 101A can be likely to be detected from the database.

In a case of updating the database D1, the DB update unit 107A first acquires each piece of information recorded in the database D1, and transforms the information into a feature vector by the transformation model 111A. Then, the DB update unit 107A updates the database D1 by overwriting each feature vector (feature vector associated with the same information) recorded in the database D1 with each feature vector obtained by the transformation.

### (Flow of Processing)

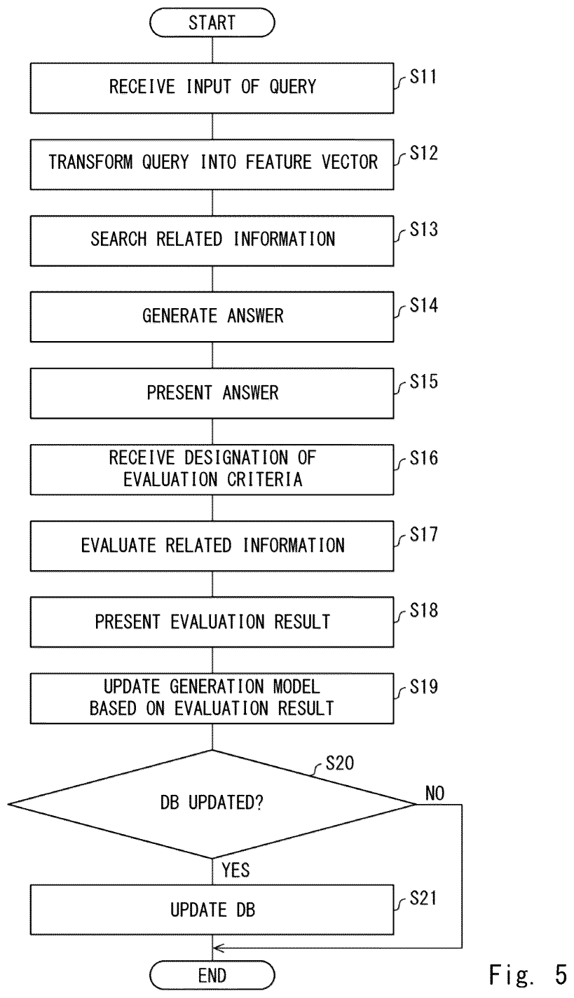

A flow of processing executed by the information processing apparatus 1A will be described with reference to FIG. 5. FIG. 5 is a flowchart illustrating a flow of processing executed by the information processing apparatus 1A. FIG. 5 includes steps of the update method of the example embodiment.

In S11, the reception unit 103A receives an input of the query. Next, in S12, the search unit 104A inputs the query received in S11 to the transformation model 111A and transforms the query into a feature vector.

In S13, the search unit 104A performs search using the feature vector generated by the transformation in S12, and detects related information related to the query received in S11. This search may be performed for a predetermined database such as the database D1 illustrated in FIG. 4, for example. In S13, the search unit 104A may detect a plurality of pieces of related information. For example, the search unit 104A may detect a predetermined number of pieces of information having a higher degree of similarity between the feature vector associated with the information and the feature vector generated by the transformation in S12 among the pieces of information recorded in the database D1 as the related information.

In S14, the generation control unit 105A inputs the feature vector generated by the transformation in S12 (or the query received in S11) and the related information detected in S13 to the generation model 112A, and generates an answer to the query received in S11. Then, in S15, the presentation control unit 106A presents the answer generated in S14 to the user.

In S16, the reception unit 103A receives designation of the evaluation criteria of the related information detected in S13. The reception of the designation of the evaluation criteria may be performed, for example, by presenting candidate evaluation criteria to the user and allowing the user to select an evaluation criterion from the candidates. In a case where the evaluation model 113A is a language model, the evaluation criteria may be freely input in a natural language. The designation of the evaluation criteria for the related information may be received at any timing earlier than the processing of S17 for evaluating the related information. For example, the processing of S16 may be performed before S11, or designation of the evaluation criteria may be received together with the query in S11. In addition, a plurality of evaluation criteria may be determined in advance, and the weight of each evaluation criterion may be designated by the user.

In S17 (evaluation processing), the evaluation unit 101A evaluates the related information detected in S13 using the evaluation model 113A. More specifically, the evaluation unit 101A inputs the related information detected in S13 and the evaluation criteria designated in S16 to the evaluation model 113A, and outputs an evaluation result of the related information. In this manner, by receiving the designation of the evaluation criteria and inputting the evaluation criteria to the evaluation model 113A, it is possible to obtain an effect of performing evaluation according to the evaluation criteria desired by the user in addition to the effect obtained by the information processing apparatus 1.

In S18, the presentation control unit 106A presents the evaluation result in S17 to the user. At this time, the reception unit 103A may receive user's correction of the presented evaluation result. As a result, the transformation model 111A can be updated based on the evaluation result according to the user's intention.

In S19 (update processing), the training unit 102A updates the transformation model 111A based on the evaluation result of S17. As described above, the training unit 102A may update the transformation model 111A such that the degree of similarity between the feature vector of the related information and the feature vector of the query becomes higher as the evaluation result by the evaluation unit 101A becomes better.

In S20, the DB update unit 107A determines whether to update a database (for example, the database D1 illustrated in FIG. 4) as a search target of related information. In a case where NO is determined in S20, the processing of FIG. 5 ends. On the other hand, in a case where YES is determined in S20, the processing proceeds to S21. The update condition of the database may be determined in advance. For example, a condition that the cumulative number of update times of the transformation model 111A after the update of the previous database has reached a predetermined number or that a predetermined period has elapsed since the update of the previous database may be used as the update condition of the database.

In S21, the DB update unit 107A updates a database (for example, the database D1 illustrated in FIG. 4) as a search target of the related information. Accordingly, the processing of FIG. 5 ends. After S15, the processing may return to S11 to receive an input of a new query.

### Modified Examples

An executing entity of each processing described in the above-described example embodiments is optional, and is not limited to the above-described examples. For example, a system having functions similar to those of the information processing apparatuses 1 and 1A can be constructed by a plurality of apparatuses capable of communicating with each other. The execution subject of each processing illustrated in the flowchart illustrated in FIG. 5 may be one apparatus (also referred to as a processor) or a plurality of apparatuses (also referred to as a processor).

### [Example of Implementation by Software]

Some or all of the functions of the information processing apparatuses 1 and 1A (hereinafter, also referred to as “each of the above apparatuses”) may be implemented by hardware such as an integrated circuit (IC chip) or may be implemented by software.

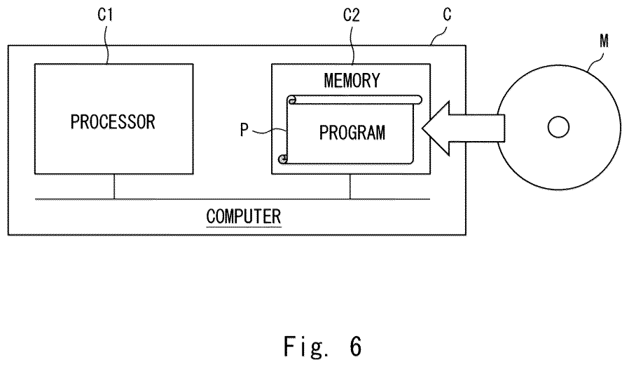

In the latter case, each of the above apparatuses is implemented by, for example, a computer that executes a command of a program which is software for implementing each function. An example of such a computer (hereinafter, referred to as a computer C) is illustrated in FIG. 6. FIG. 6 is a block diagram illustrating a hardware configuration of the computer C functioning as each of the above apparatuses.

The computer C includes at least one processor C1 and at least one memory C2. A program (update program) P for operating the computer C as each of the above apparatuses is recorded in the memory C2. In the computer C, the processor C1 reads the program P from the memory C2 and executes the program P to implement each function of each of the above apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other apparatuses. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above apparatuses may be implemented by one processor provided in one computer, may be implemented in cooperation with a plurality of processors provided in one computer, or may be implemented in cooperation with a plurality of processors provided in a plurality of computers, respectively. The program causing each of the above apparatuses to implement each of the above functions may be stored in one memory provided in one computer, may be stored in a distributed manner in a plurality of memories provided in one computer, or may be stored in a distributed manner in a plurality of memories provided in a plurality of computers, respectively.

### [Supplementary Notes]

The present disclosure includes the technologies described in the following supplementary notes. However, the present disclosure is not limited to the techniques described in the following supplementary notes, and various modifications can be made within the scope described in the claims.

### (Supplementary Note A1)

An information processing apparatus includes an evaluation unit that evaluates related information on an input query detected by search using a feature vector obtained by transforming the query with a transformation model, by using an evaluation model that receives data to be evaluated and an evaluation criterion to output an evaluation result obtained by evaluating the data with the evaluation criterion, and a training unit that updates the transformation model based on the evaluation result of the evaluation unit.

### (Supplementary Note A2)

The information processing apparatus according to Supplementary Note A1, further including: a reception unit that receives designation of an evaluation criterion for evaluating the related information of the query, in which the evaluation unit inputs the related information of the query and the designated evaluation criterion to the evaluation model, and outputs an evaluation result of the related information.

### (Supplementary Note A3)

The information processing apparatus according to Supplementary Note A1 or A2, further including a presentation control unit that presents an evaluation result by the evaluation unit to a user.

### (Supplementary Note A4)

The information processing apparatus according to any one of Supplementary Notes A1 to A3, in which the search is performed for a database in which each piece of information that is a candidate for the related information and a feature vector of each piece of information are recorded in association with each other, and the information processing apparatus further includes a DB update unit that updates each feature vector recorded in the database with a feature vector obtained by transforming each piece of information recorded in the database by the transformation model after being updated by the training unit.

### (Supplementary Note A5)

The information processing apparatus according to any one of Supplementary Notes A1 to A4, in which the evaluation model is a language model trained on natural language.

### (Supplementary Note A6)

The information processing apparatus according to any one of Supplementary Notes A1 to A5, in which the training unit updates the transformation model such that degree of similarity between a feature vector of related information and a feature vector of the query becomes higher as the evaluation result of the related information by the evaluation unit is better.

### (Supplementary Note A7)

The information processing apparatus according to Supplementary Note A6, in which the training unit updates the transformation model using a loss function indicating a difference between a probability distribution of degree of similarity between the feature vector of the query and the feature vector of the related information and a probability distribution of a numerical value indicating an evaluation result of the related information.

### (Supplementary Note A8)

The information processing apparatus according to Supplementary Note A6, in which the training unit updates the transformation model by reinforcement training using the evaluation result by the evaluation unit as a reward.

### (Supplementary Note B1)

A method of updating a transformation model causing at least one processor to execute: evaluation processing of evaluating related information on an input query detected by search using a feature vector obtained by transforming the query with a transformation model, by using an evaluation model that receives data to be evaluated and an evaluation criterion to output an evaluation result obtained by evaluating the data with the evaluation criterion; and update processing of updating the transformation model based on the evaluation result of the evaluation processing.

### (Supplementary Note B2)

The update method according to Supplementary Note B1, further causing the at least one processor to execute reception processing of receiving designation of an evaluation criterion for evaluating related information of the query, and in the evaluation processing, the at least one processor is caused to input the related information of the query and the designated evaluation criterion to the evaluation model, and output the evaluation result of the related information.

### (Supplementary Note B3)

The update method according to Supplementary Note B1 or B2, further causing the at least one processor to execute presentation control processing of presenting the evaluation result by the evaluation processing to a user.

### (Supplementary Note B4)

The update method according to any one of Supplementary Notes B1 to B3, in which the search is performed for a database in which each piece of information that is a candidate for the related information and a feature vector of each piece of information are recorded in association with each other, and the method causes the at least one processor to execute DB update processing of updating each feature vector recorded in the database with a feature vector obtained by transforming each piece of information recorded in the database by the transformation model after being updated by the training processing.

### (Supplementary Note B5)

The update method according to any one of Supplementary Notes B1 to B4, in which the evaluation model is a language model obtained by training a natural language.

### (Supplementary Note B6)

The update method according to any one of Supplementary Notes B1 to B5, in which in the training processing, the at least one processor is caused to update the transformation model such that in the training processing, degree of similarity between a feature vector of related information and a feature vector of the query becomes higher as the evaluation result of the related information by the evaluation processing is better.

### (Supplementary Note B7)

The update method according to Supplementary Note B6, in which in the training processing, the at least one processor is caused to update the transformation model using a loss function indicating a difference between a probability distribution of similarity between the feature vector of the query and the feature vector of the related information and a probability distribution of a numerical value indicating an evaluation result of the related information.

### (Supplementary Note B8)

The update method according to Supplementary Note B6, in which in the training processing, the at least one processor is caused to update the transformation model by reinforcement training using the evaluation result by the evaluation unit as a reward.

### (Supplementary Note C1)

An update program of a transformation model for causing a computer to function as an evaluation unit that evaluates related information on an input query detected by search using a feature vector obtained by transforming the query with a transformation model, by using an evaluation model that receives data to be evaluated and an evaluation criterion to output an evaluation result obtained by evaluating the data with the evaluation criterion, and a training unit that updates the transformation model based on the evaluation result of the evaluation unit.

### (Supplementary Note C2)

The update program according to Supplementary Note C1, further causing the computer to function as a reception unit that receives designation of an evaluation criterion for evaluating the related information of the query, in which the evaluation unit inputs the related information of the query and the designated evaluation criterion to the evaluation model, and outputs an evaluation result of the related information.

### (Supplementary Note C3)

The update program according to Supplementary Note C1 or C2, further causing the computer to function as a presentation control unit for presenting the evaluation result by the evaluation unit to a user.

### (Supplementary Note C4)

The update program according to any one of Supplementary Notes C1 to C3, in which the search is performed for a database in which each piece of information that is a candidate for the related information and a feature vector of each piece of information are recorded in association with each other, and the program further causes the computer to function as a DB update unit that updates each feature vector recorded in the database with a feature vector obtained by transforming each piece of information recorded in the database by the transformation model after being updated by the training unit.

### (Supplementary Note C5)

The update program according to any one of Supplementary Notes C1 to C4, in which the evaluation model is a language model trained on natural language.

### (Supplementary Note C6)

The update program according to any one of Supplementary Notes C1 to C5, in which the training unit updates the transformation model such that degree of similarity between a feature vector of related information and a feature vector of the query becomes higher as the evaluation result of the related information by the evaluation unit is better.

### (Supplementary Note C7)

The update program according to Supplementary Note C6, in which the training unit updates the transformation model using a loss function indicating a difference between a probability distribution of degree of similarity between the feature vector of the query and the feature vector of the related information and a probability distribution of a numerical value indicating an evaluation result of the related information.

### (Supplementary Note C8)

The update program according to Supplementary Note C6, in which the training unit updates the transformation model by reinforcement training using the evaluation result by the evaluation unit as a reward.

### (Supplementary Note D1)

An information processing apparatus including at least one processor, in which the at least one processor executes evaluation processing of evaluating related information on an input query detected by search using a feature vector obtained by transforming the query with a transformation model, by using an evaluation model that receives data to be evaluated and an evaluation criterion to output an evaluation result obtained by evaluating the data with the evaluation criterion, and training processing of updating the transformation model based on the evaluation result of the evaluation processing.

The information processing apparatus may further include a memory. The memory may store a program for causing the at least one processor to execute each of the processing.

### (Supplementary Note D2)

The information processing apparatus according to Supplementary Note D1, further causing the at least one processor to execute reception processing of receiving designation of an evaluation criterion for evaluating related information of the query, and in the evaluation processing, the at least one processor is caused to input the related information of the query and the designated evaluation criterion to the evaluation model, and output the evaluation result of the related information.

### (Supplementary Note D3)

The information processing apparatus according to Supplementary Note D1 or D2, further causing the at least one processor to execute presentation control processing of presenting the evaluation result by the evaluation processing to a user.

### (Supplementary Note D4)

The information processing apparatus according to any one of Supplementary Notes D1 to D3, in which the search is performed for a database in which each piece of information that is a candidate for the related information and a feature vector of each piece of information are recorded in association with each other, and the at least one processor executes DB update processing of updating each feature vector recorded in the database with a feature vector obtained by transforming each piece of information recorded in the database by the transformation model after being updated by the training processing.

### (Supplementary Note D5)

The information processing apparatus according to any one of Supplementary Notes D1 to D4, in which the evaluation model is a language model trained on natural language.

### (Supplementary Note D6)

The information processing apparatus according to any one of Supplementary Notes D1 to D5, in which in the training processing, the at least one processor updates the transformation model such that in the training processing, degree of similarity between a feature vector of related information and a feature vector of the query becomes higher as the evaluation result of the related information by the evaluation processing is better.

### (Supplementary Note D7)

The information processing apparatus according to Supplementary Note D6, in which in the training processing, the at least one processor updates the transformation model using a loss function indicating a difference between a probability distribution of similarity between the feature vector of the query and the feature vector of the related information and a probability distribution of a numerical value indicating an evaluation result of the related information.

### (Supplementary Note D8)

The information processing apparatus according to Supplementary Note D6, in which in the training processing, the at least one processor updates the transformation model by reinforcement training using an evaluation result by the evaluation processing as a reward.

### (Supplementary Note E)

A non-transitory medium storing an update program for causing a computer to execute: evaluation processing of evaluating related information on an input query detected by search using a feature vector obtained by transforming the query with a transformation model, by using an evaluation model that receives data to be evaluated and an evaluation criterion to output an evaluation result obtained by evaluating the data with the evaluation criterion; and training processing of updating the transformation model based on the evaluation result of the evaluation processing.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing apparatus comprising:
a memory that stores an instruction; and
a processor that evaluates related information on an input query detected by search using a feature vector obtained by transforming the query with a transformation model, by using an evaluation model that receives data to be evaluated and an evaluation criterion to output an evaluation result obtained by evaluating the data with the evaluation criterion, and executes an instruction for updating the transformation model based on the evaluation result.

2. The information processing apparatus according to claim 1, wherein
the processor executes an instruction to receive designation of an evaluation criterion for evaluating related information of the query, and
the evaluating includes inputting the related information of the query and the designated evaluation criterion to the evaluation model, and outputting the evaluation result of the related information.

3. The information processing apparatus according to claim 1, wherein the processor executes an instruction to present the evaluation result to a user.

4. The information processing apparatus according to claim 1, wherein
the search is performed for a database in which each piece of information that is a candidate for the related information and a feature vector of each piece of information are recorded in association with each other, and
the processor further executes an instruction to update each feature vector recorded in the database with a feature vector obtained by transforming each piece of information recorded in the database with the transformation model after update by updating the transformation model.

5. The information processing apparatus according to claim 1, wherein the evaluation model is a language model obtained by training a natural language.

6. The information processing apparatus according to claim 1, wherein updating the transformation model includes updating the transformation model such that degree of similarity between a feature vector of related information and a feature vector of the query becomes higher as the evaluation result of the related information is better.

7. The information processing apparatus according to claim 6, wherein updating the transformation model includes updating the transformation model using a loss function indicating a difference between a probability distribution of degree of similarity between the feature vector of the query and the feature vector of the related information and a probability distribution of a numerical value indicating an evaluation result of the related information.

8. The information processing apparatus according to claim 6, wherein updating the transformation model includes updating the transformation model by reinforcement training using the evaluation result as a reward.

9. A method of updating a transformation model for causing at least one processor to execute:
evaluating related information on an input query detected by search using a feature vector obtained by transforming the query with a transformation model, by using an evaluation model that receives data to be evaluated and an evaluation criterion to output an evaluation result obtained by evaluating the data with the evaluation criterion; and
updating the transformation model based on the evaluation result.

10. The method of updating the transformation model according to claim 9, further causing the processor to execute an instruction to receive designation of an evaluation criterion for evaluating related information of the query,
wherein the evaluating includes inputting the related information of the query and the designated evaluation criterion to the evaluation model, and outputting the evaluation result of the related information.

11. The method of updating the transformation model according to claim 9, further causing the processor to execute an instruction to present the evaluation result to a user.

12. The method of updating the transformation model according to claim 9, wherein
the search is performed for a database in which each piece of information that is a candidate for the related information and a feature vector of each piece of information are recorded in association with each other, and
the processor further executes an instruction to update each feature vector recorded in the database with a feature vector obtained by transforming each piece of information recorded in the database with the transformation model after update by updating the transformation model.

13. The method of updating the transformation model according to claim 9, wherein the evaluation model is a language model trained on natural language.

14. The method of updating the transformation model according to claim 9, wherein updating the transformation model includes updating the transformation model such that degree of similarity between a feature vector of related information and a feature vector of the query becomes higher as the evaluation result of the related information is better.

15. The method of updating the transformation model according to claim 14, wherein updating the transformation model includes updating the transformation model using a loss function indicating a difference between a probability distribution of degree of similarity between the feature vector of the query and the feature vector of the related information and a probability distribution of a numerical value indicating an evaluation result of the related information.

16. The method of updating the transformation model according to claim 14, wherein updating the transformation model includes updating the transformation model by reinforcement training using the evaluation result as a reward.

17. A non-transitory computer-readable medium storing an update program of a transformation model for causing a computer to execute:
evaluating related information on an input query detected by search using a feature vector obtained by transforming the query with a transformation model, by using an evaluation model that receives data to be evaluated and an evaluation criterion to output an evaluation result obtained by evaluating the data with the evaluation criterion; and
updating the transformation model based on the evaluation result.

18. The non-transitory computer-readable medium storing an update program of a transformation model according to claim 17, further causing the computer to execute an instruction to receive designation of an evaluation criterion for evaluating related information of the query,
wherein the evaluating includes inputting the related information of the query and the designated evaluation criterion to the evaluation model, and outputting the evaluation result of the related information.

19. The non-transitory computer-readable medium storing an update program of a transformation model according to claim 17, further causing the computer to present the evaluation result to a user.

20. The non-transitory computer-readable medium storing an update program of a transformation model according to claim 17, wherein
the search is performed for a database in which each piece of information that is a candidate for the related information and a feature vector of each piece of information are recorded in association with each other, and
the update program further causes the computer to execute an instruction to update each feature vector recorded in the database with a feature vector obtained by transforming each piece of information recorded in the database with the transformation model after update by updating the transformation model.
